(19) United States
(12) Patent Application Publication
(10) Pub. No.: US 2021/0396264 A1
(43) Pub. Date: Dec. 23, 2021

(54) PRESSURE NUT FOR CABLE OR TUBE CONNECTIONS

(71) Applicant: LEONI KABEL GMBH, Roth (DE)

(72) Inventors: PHILIPP KNAUER, Lisberg (DE); Jens Hofmockel, Windsbach (DE); Benjamin Kiessling, Stein (DE)

(21) Appl. No.: 17/346,526

(22) Filed: Jun. 14, 2021

(30) Foreign Application Priority Data
Jun. 19, 2020 (DE) 102020116248.0

(51) Int. Cl. F16B 37/08

(52) U.S. Cl. CPC F16B 37/0892

(57) ABSTRACT

A pressure nut for cable or tube connections includes a first pressure nut component, which has a slot, and a second pressure nut component designed to close the slot in the first pressure nut component. The first pressure nut component and the second pressure nut component are connectable to one another.

### RELATED APPLICATIONS

The present invention claims priority of DE 10 2020 116 248.0, filed on Jun. 19, 2020, the entirety of which is incorporated herein by reference.

### TECHNICAL FIELD

The present disclosure relates to a pressure nut for cable or tube connections.

### BACKGROUND

Cables and tubes that are exposed to high forces and/or torques often have a bushing on their respective attachment section. This bushing can be firmly bonded to the cable sheath or connected to it in another manner. This bushing can be attached by a pressure nut to an attachment point for the cable or for the tube.

The object of this disclosure is to provide a pressure nut which can absorb high forces, requires little installation space and is easy and inexpensive to manufacture.

### SUMMARY

The pressure nut for cable or tube connections includes a first pressure nut component, which has a slot, and a second pressure nut component, the second pressure nut component being designed to close the slot in the first pressure nut component, the first pressure nut component and the second pressure nut component being connectable to one another.

The pressure nut can be pushed onto a cable or a tube via the slot. In particular, the pressure nut permits the first pressure nut component to be pushed onto the cable or the tube close to the actual attachment point. Following pushing on of the first pressure nut component, the first pressure nut component is connected to the second pressure nut component. The pressure nut can then be connected to its actual counterpart to attach the cable or the tube.

Removal of the pressure nut from the cable or the tube can take place in a reverse manner. The first pressure nut component and the second pressure nut component are separated. Following the separation, the first pressure nut component can be removed from the cable or the tube via the slot.

The first pressure nut component can enclose a larger angle than the second pressure nut component. The first pressure nut component can enclose an angle of 200° to 300°. The first pressure nut component can preferably enclose an angle of 250° to 290°. The second pressure nut component can enclose an angle of 60° to 160°. The second pressure nut component can preferably enclose an angle of 70° to 110°. The slot of the first pressure nut component can enclose an angle of 60° to 160°.

The first pressure nut component can have an internal thread section. The second pressure nut component can be formed thread-free. The second pressure nut component can be formed without an internal thread section on its inside. The second pressure nut component without an internal thread section can interrupt the internal thread section on the inside of the first pressure nut component. The manufacture of the pressure nut can be simplified by the second pressure nut component without an internal thread section, as no coordination of the internal thread on the first pressure nut component to the internal thread on the second pressure nut component has to take place.

The first pressure nut component and the second pressure nut component can be designed and/or connected to one another so that a tightening torque for tightening the pressure nut cannot separate the two pressure nut components.

The first pressure nut component and the second pressure nut component can be connected to one another via attachment elements. To this end the first pressure nut component and the second pressure nut component can have openings into which attachment elements can be introduced. The attachment elements can extend into the pressure nut components in an axial direction of the pressure nut. Attachment elements can be screws or bolts, for example. Furthermore, the first pressure nut component and the second pressure nut component can be connected to one another via a bayonet fitting.

The first pressure nut component and the second pressure nut component can have complementary attachment structures, which serve to connect the first pressure nut component and the second pressure nut component to one another. The complementary attachment structures can be, for example, attachment recesses and/or attachment sections. The attachment sections can protrude or stick out from one of the pressure nut components. The attachment sections can be formed curved. At least one attachment recess can be formed on the first pressure nut component. The second pressure nut component can have at least one attachment section, which can be received in the at least one attachment recess on the first pressure nut component. Alternatively, the first pressure nut component can have at least one attachment section, which can be received in the at least one attachment recess on the second pressure nut component. The at least one attachment recess and/or the at least one attachment section can each have at least one opening into which at least one attachment element can be introduced to connect the two pressure nut components.

The at least one attachment recess can have a base surface and a lateral surface. The lateral surface can extend substantially perpendicular to the base surface. The lateral surface can extend between the base surface and an end face of the pressure nut. The at least one attachment section can have a contact surface and an end surface. The end surface can extend substantially perpendicular to the contact surface. The end surface can extend between the contact surface and an end face of the pressure nut. The contact surface of the attachment section can serve to rest on the base surface of the attachment recess. The end surface of the attachment section can be supported on the lateral surface of the attachment recess.

The first pressure nut component can have two end surfaces which define the slot between them. The two end surfaces can extend at least substantially parallel to one another. The two end surfaces of the first pressure nut component can lie opposite one another. The slot can extend over the entire axial extension of the first pressure nut component. The slot can be designed as an insertion opening for a cable and/or a bushing.

The second pressure nut component can have a main body. The main body can have two lateral surfaces. The two lateral surfaces of the main body can extend at least substantially parallel to one another. The second pressure nut component can have at least one attachment section, which can extend laterally away from the main body. The attachment section can be formed curved. The at least one attachment section can have a radius of curvature that corresponds at least substantially to the radius of the pressure nut.

The pressure nut can have a through opening. The through opening can be defined by the first pressure nut component and the second pressure nut component. The through opening can have a section that acts as a clamping surface. The section acting as a clamping surface can be formed conical or oblique in cross section. The through opening can have a section with a larger internal diameter, i.e. a larger-diameter section, and a section with a smaller internal diameter, i.e. a smaller-diameter section. These two sections can be connected to one another via the section acting as a clamping surface. This section can thus connect the larger-diameter section to the smaller-diameter section.

The present disclosure further relates to an assembly with at least one pressure nut and with at least one bushing that is connectable or connected to a cable. The assembly can further have at least one threaded sleeve. The at least one threaded sleeve can have a first external thread section and a second external thread section. A web can be provided between the first external thread section and the second external thread section. The pressure nut can be screwed to the threaded sleeve. The internal thread section on the first pressure nut component can be screwed to an external thread section of the threaded sleeve. A clamping area can be defined between the threaded sleeve and the section of the through opening of the pressure nut acting as a clamping surface. A projection on the bushing can be received and clamped in this clamping area.

### BRIEF DESCRIPTION OF THE DRAWINGS

Exemplary embodiments are described below with reference to the enclosed figures. There are depicted:

FIG. 1 a perspective view of a pressure nut;

FIG. 2 a sectional view of the pressure nut;

FIG. 3 an exploded representation of the pressure nut;

FIG. 4 another exploded representation of the pressure nut;

FIG. 5 a view of an assembly with a pressure nut and a threaded sleeve in the state connected to one another;

FIG. 6 a sectional view of the assembly according to FIG. 5;

FIG. 7 a perspective view of an assembly with a pressure nut, a threaded sleeve and a bushing, which is connected to a cable;

FIG. 8 a sectional view of the assembly according to FIG. 7;

FIG. 9 a perspective view of a first pressure nut component and a second pressure nut component of the pressure nut in the separated state as well as of a cable; and

FIG. 10 a plan view of the first pressure nut component, the second pressure nut component and the cable.

### DETAILED DESCRIPTION

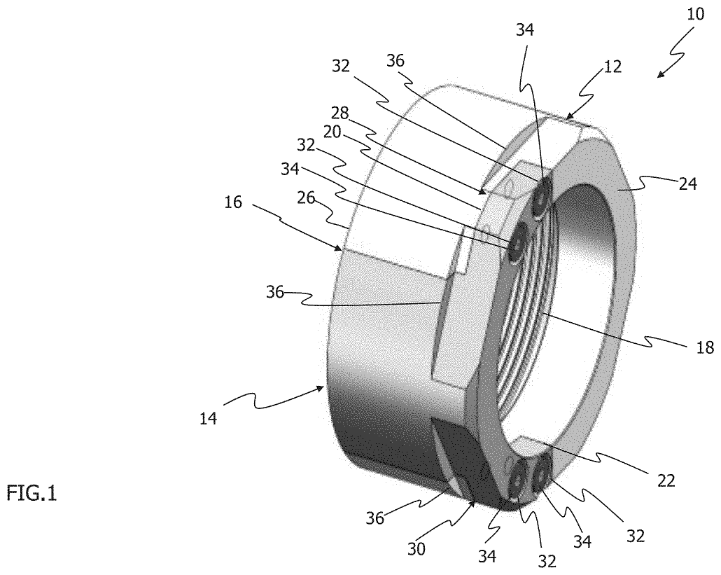

FIG. 1 shows a perspective view of a pressure nut 10. The pressure nut 10 has a first pressure nut part 12 and a second pressure nut part 14. The first pressure nut component 12 has a slot 16 in which the second pressure nut component 14 is received. The section 16 extends over the entire axial extension of the first pressure nut component 12. The first pressure nut component 12 has an internal thread section 18. The first pressure nut component 12 is larger than the second pressure nut component 14. The first pressure nut component 12 can enclose an angle of 200° to 300°. The second pressure nut component 14 can enclose an angle of 60° to 160°.

Attachment recesses 20 and 22 are provided on the first pressure nut component 12. The attachment recesses 20 and 22 extend, starting from the slot 16, in a circumferential direction into the first pressure nut component 12. The attachment recesses 20 and 22 are formed on one of the end faces 24, 26 of the first pressure nut component 12, i.e. on the end face 24 in the embodiment shown.

The second pressure nut component 14 has two attachment sections 28 and 30, which are formed curved. The attachment sections 28 and 30 can also be described as attachment arms. The attachment sections 28 and 30 can be received in the attachment recesses 20 and 22 of the first pressure nut component 12. The attachment sections 28 and 30 have openings 32 through which screws 34 can extend. The openings 32 extend in an axial direction of the pressure nut 10 through the attachment sections 28 and 30 into the first pressure nut component 12. Formed on the external circumferential surface of the pressure nut 10 are application recesses 36, which can be used as application points for a tool (not shown). The application recesses 36 extend also in transition areas between the first pressure nut component 12 and the second pressure nut component 14. In this case a portion of the corresponding application recess 36 is located on the first pressure nut component 12 and the remaining portion of the application recess 36 on the second pressure nut component 14. Starting out from the end face 24, the application recesses 36 extend in an axial direction over a predetermined section of the external circumferential surface of the pressure nut 10. The application recesses 36 end with a shoulder, which marks the transition to the external circumferential surface of the pressure nut 10.

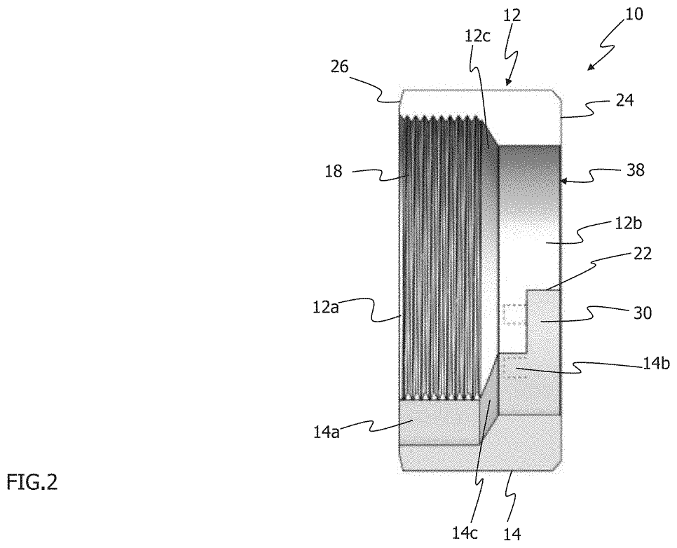

FIG. 2 shows a sectional view of the pressure nut 10. In the sectional view according to FIG. 2, the first pressure nut component 12 and the second pressure nut component 14 are shown in section. The pressure nut 10 has a through opening 38. In the assembled state, the first pressure nut component 12 and the second pressure nut component 14 define the through opening 38 between them. With regard to the inner diameter, the through opening 38 has a larger-diameter section 12a, 14a, a smaller-diameter section 12b, 14b and a conical section 12c, 14c, which connects the larger-diameter section 38a and the smaller-diameter section 38b to one another. The conical section 12c, 14c forms a clamping surface. The sections 12a, 12b and 12c are formed on the first pressure nut component 12. The sections 14a, 14b and 14c are formed on the second pressure nut component 14. The opening 38 is thus formed stepped.

The attachment recess 22 on the first pressure nut component 12 and the attachment section 30 on the second pressure nut component 14 are formed in the smaller-diameter section 12b, 14b of the opening 38. The same applies to the attachment recess 20 and the attachment section 28, which are not depicted in FIG. 2, however.

The first pressure nut component 12 has the internal thread section 18. The second pressure nut component 14 is formed without an internal thread, i.e. the second pressure nut component 14 is formed thread-free. The internal thread section 18 is formed on the first pressure nut component 12 in section 12a. The second pressure nut component 14 interrupts the internal thread, as section 14a of the second pressure nut component 14 has no internal thread.

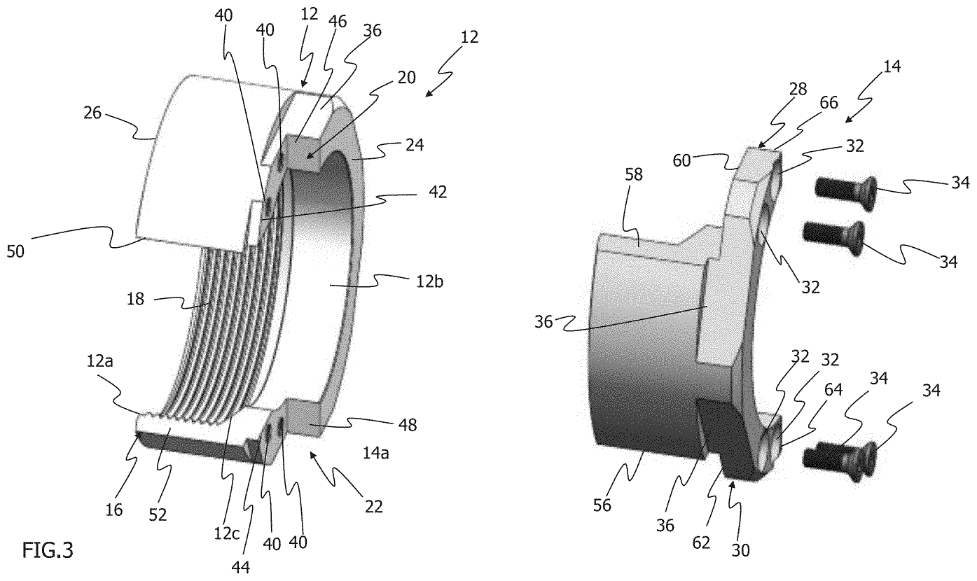

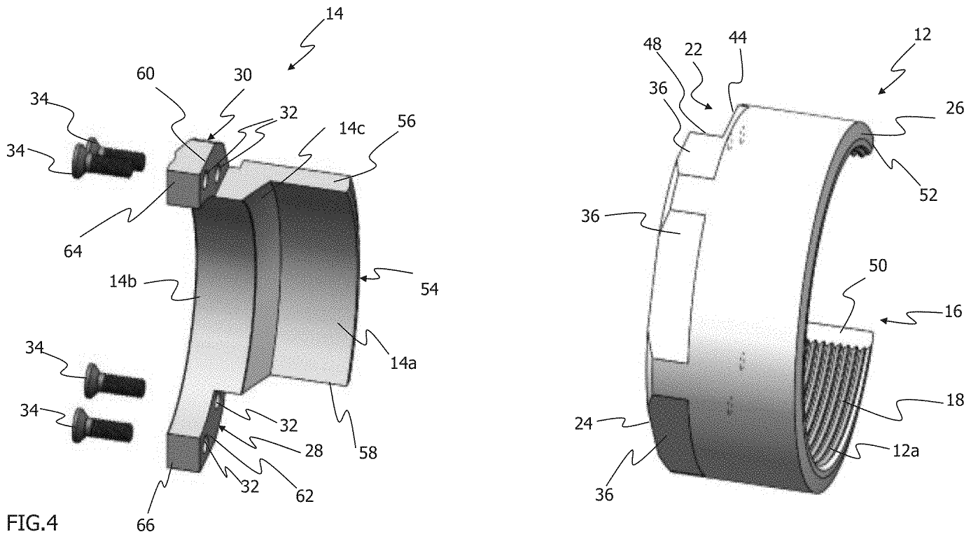

FIGS. 3 and 4 show exploded representations of the pressure nut 10, wherein the viewing angle of the exploded representations according to FIGS. 3 and 4 differs. In the exploded representations according to FIGS. 3 and 4, the first pressure nut component 12 and the second pressure nut component 14 are depicted separated from one another.

The first pressure nut component 12 has end faces 24 and 26. The internal thread section 18 or the larger-diameter section 12a with the internal thread section 18 extends between the end face 26 and the oblique section 12c. The smaller-diameter section 12b extends between section 12c and the end face 24. The first pressure nut component 12 has the attachment recesses 20 and 22, which extend starting from the end face 24 into the pressure nut component 12.

The attachment recesses 20 and 22 are each formed by a base surface 42, 44 and a lateral surface 46, 48. Formed in the base surfaces 42, 44 of the attachment recesses 20 and 22 are openings 40, into which the screws 34 extend for connecting the first pressure nut component 12 to the second pressure nut component 14. The lateral surfaces 46 and 48 connect the base surfaces 42 and 44 to the end face 24. The lateral surfaces 46 and 48 extend substantially perpendicular to the end face 24 and to the base surface 42, 44 of the respective attachment recesses 20, 22.

The first pressure nut component 12 has the slot 16, which extends over the entire axial extension of the first pressure nut component 12. The end surfaces 50 and 52 of the first pressure nut component 12 define the slot 16 between them. The end surfaces 50 and 52 extend substantially parallel to one another. The slot 16 of the first pressure nut component 12 can be closed by the second pressure nut component 14. The second pressure nut component 14 is designed for take-up in the slot 16.

The second pressure nut component 14 has a main body 54. The attachment sections 28 and 30 extend laterally away from the main body 54. The attachment sections 28 and 30 are curved according to the diameter or radius of the pressure nut 10. The attachment sections 28 and 30 are used for connection to the first pressure nut component 12. The second pressure nut component 14 can be placed with its main body 54 onto the end surfaces 50 and 52 of the first pressure nut component 12. The main body 54 has lateral surfaces 56 and 58. The lateral surfaces 56 and 58 of the main body 54 extend substantially parallel to one another. The lateral surfaces 56 and 58 also extend in an axial direction of the pressure nut 10. The lateral surfaces 56 and 58 of the main body 54 can extend parallel to the end surfaces 50, 52 of the first pressure nut component 12.

The second pressure nut component 14 has on its inside the larger-diameter section 14a and the smaller-diameter section 14b, which are connected via the oblique section 14c. As is recognisable in particular in FIG. 4, the second pressure nut component 14 has no internal thread section on its inside. The second pressure nut component 14 is thus formed thread-free.

The attachment sections 28 and 30 are formed in an axial direction in section 14b. The attachment sections 28 and 30 are thus formed in the area between the oblique section 14c and the end face 24 (see also FIGS. 1 and 2). The attachment sections 28 and 30 extend laterally away from the main body 54 of the second pressure nut component 14. Extending through the attachment sections 28 and 30 are the openings 32, through which the screws 34 for connecting the second pressure nut component 14 to the first pressure nut component 12 can be guided. The attachment sections 28 and 30 each have a contact surface 60, 62 and an end surface 64 and 66. The end surfaces 64, 66 extend substantially perpendicular to the contact surfaces 60, 62. The attachment sections 28 and 30 are placed with the contact surfaces 60, 62 onto the base surfaces 42, 44 of the attachment recesses 20 and 22 of the first pressure nut component 12. The end surfaces 64 and 66 of the attachment sections 28 and 30 can be supported on the lateral surfaces 46 and 48 of the attachment recesses 20 and 22. The lateral surfaces 46 and 48 of the attachment recesses 20 and 22 and the end surfaces 64 and 66 of the attachment sections 28 and 30 extend in a radial direction between the internal circumference and the external circumference of the pressure nut 10.

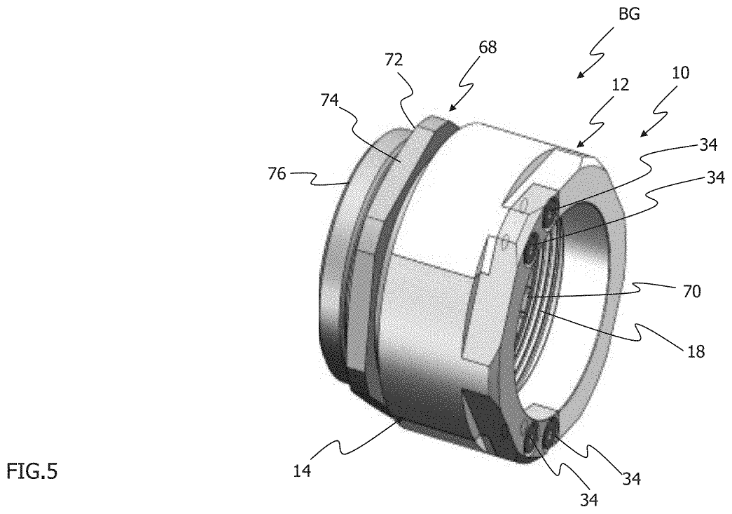

FIG. 5 shows a perspective view of an assembly BG, which has the pressure nut 10 and a threaded sleeve 68. The pressure nut 10 is screwed to the threaded sleeve 68. The pressure nut components 12, 14 are shown in the connected state in FIG. 5, i.e. the two components 12 and 14 are connected to one another via the screws 34. The threaded sleeve 68 has a first external thread section 70, which was screwed to the internal thread section 18 of the pressure nut 10. The threaded sleeve 68 has a web 72, which is formed with application surfaces 74, to which a tool can be applied. Attached to the web 70 is a second external thread section 76.

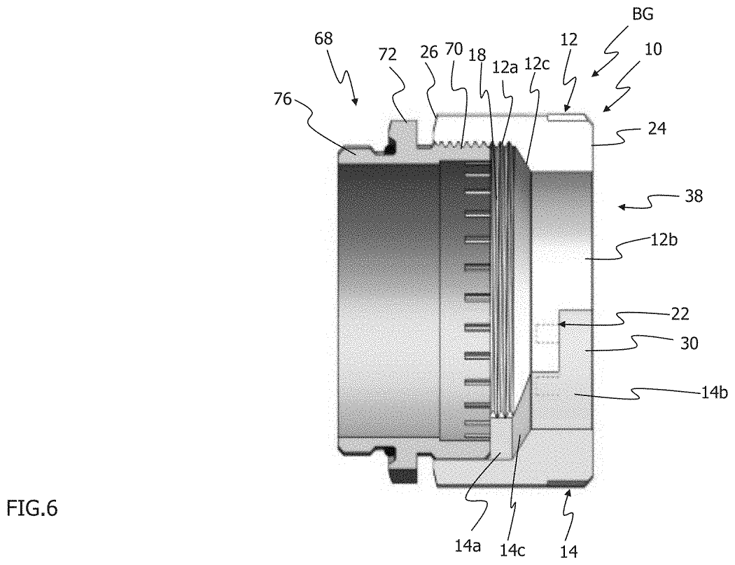

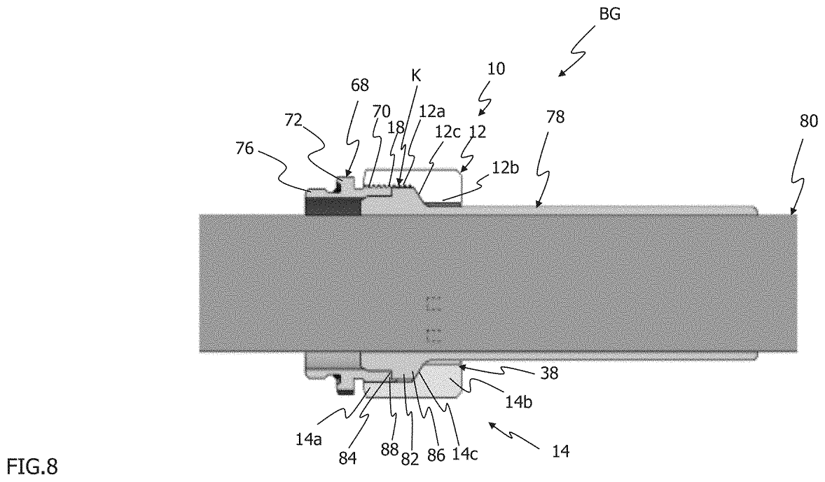

FIG. 6 shows a sectional view of the assembly BG with the pressure nut 10 and the threaded sleeve 68. The threaded sleeve 68 has the two external thread sections 70 and 76, arranged between which is the web 72. The first external thread section 70 is screwed to the internal thread section 18 of the first pressure nut component 12. As is visible again in FIG. 8, the second pressure nut component 14 has no internal thread section. The pressure nut component 14 is accordingly not screwed to the external thread section 70 of the threaded sleeve 68.

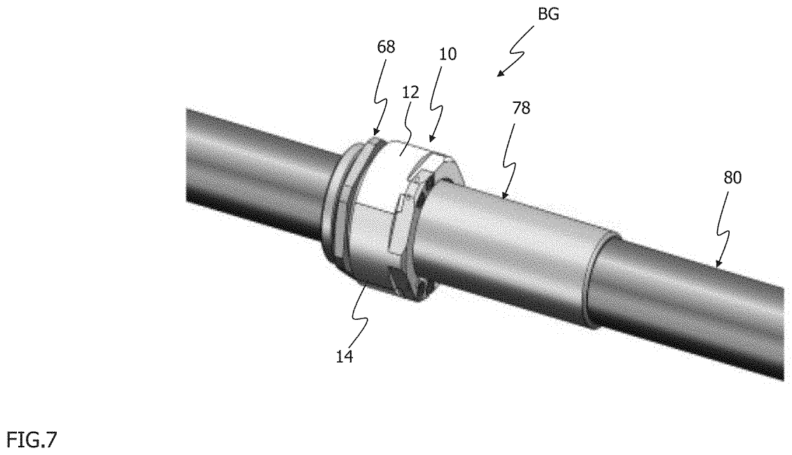

FIG. 7 shows a perspective view of an assembly BG with the pressure nut 10 and the threaded sleeve 68, which are connected to a bushing 78. The bushing 78 is fitted on a cable 80. The cable 80 extends through the bushing 78 and thus through the threaded sleeve 68 and the pressure nut 10.

FIG. 8 shows a sectional view of the assembly BG according to FIG. 7. The threaded sleeve 68 is screwed to the pressure nut 10, i.e. the external thread section 70 of the threaded sleeve 68 is screwed to the thread section 18 of the first pressure nut component 12. The pressure nut 10 holds the threaded sleeve 68 on the bushing 78. The bushing 78 has a circumferential projection 82. The projection 82 of the bushing 78 defines a contact surface 84, which can be supported on the threaded sleeve 68. The contact surface 84 extends perpendicular to the axis of the bushing 78. Connected to the contact surface 84 is a receiving section with a reduced diameter, which is taken up in the threaded sleeve 68. The receiving section extends between the contact surface 84 and the corresponding end of the bushing 78. The projection 82 further has an oblique section 86. The projection 82 is clamped between the threaded sleeve 68 and the pressure nut 10. To this end the projection 82 is received and clamped between the end face 88 of the threaded sleeve 68 and the oblique section 12c, 14c of the opening 38 of the pressure nut 10. The end face 88 of the threaded sleeve 68 is placed onto the contact surface 84 of the bushing 78. The oblique section 12c, 14c of the opening 38 of the pressure nut 10 is supported on the oblique section 86 of the bushing. The oblique section 12c, 14c thus acts as a clamping surface for the projection 82. In other words, the projection 82 is clamped between the end face 88 of the threaded sleeve 68 and the oblique section 12c, 14c of the opening 38. A clamping area K for the projection 82 of the bushing 78 is thus defined between the threaded sleeve 68 and the pressure nut 10.

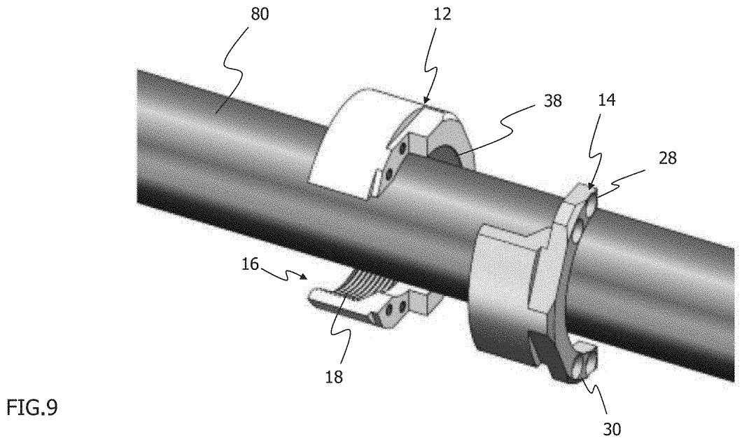

FIG. 9 shows the first pressure nut component 12 and the second pressure nut component 14 in a separated state. The first pressure nut component 12 can be pushed onto the cable 80 in this state. As shown in FIG. 9, the first pressure nut component 12 has been pushed onto the cable 80 via the slot 16. The slot 16 thus defines an insertion opening for the cable 80. The cable 80 is received in the opening 38 of the first pressure nut component 12. The slot 16 extends over the entire axial extension of the first pressure nut component 12. The slot 16 can be closed by the second pressure nut component 14. The second pressure nut component 14 is received for this purpose in the slot 16 and attached via the attachment sections 28 and 30 to the first pressure nut component 12. In the connected state of the pressure nut components 12 and 14 the pressure nut 10 can be connected to its counterpart (not shown) to attach the cable 80.

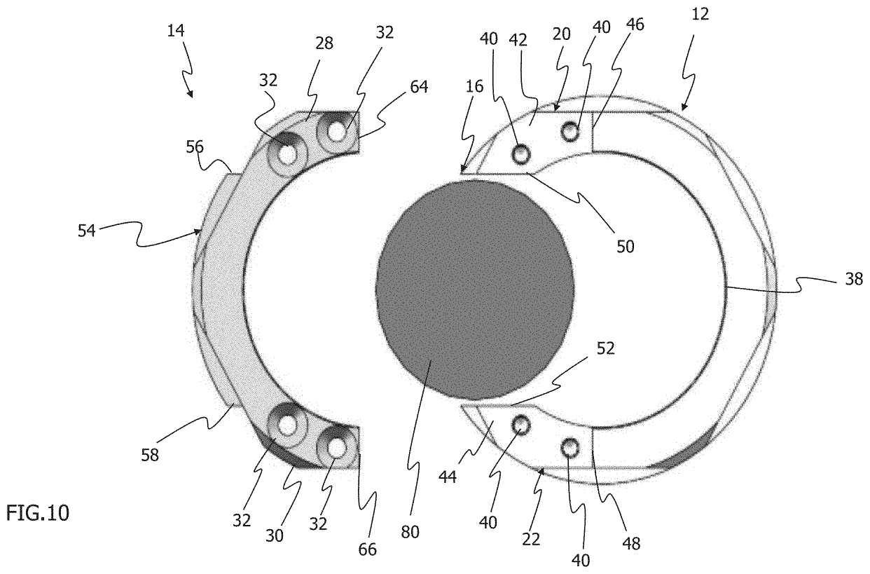

FIG. 10 shows a plan view of the first pressure nut component 12 and the second pressure nut component 14 in the separated state. The cable 80 can be inserted via the slot 16 into the opening 38 in the first pressure nut component 12. The slot 16 thus defines an insertion opening for the cable 80. The slot 16 is defined between the two end surfaces 50 and 52 of the first pressure nut component 12. The two end surfaces 50 and 52 extend substantially parallel to one another. The slot 16 can be closed via the second pressure nut component 14. The main body 54 of the second pressure nut component 14 is taken up between the end surfaces 50 and 52 of the first pressure nut component 12. The attachment sections 28 and 30 on the second pressure nut component 14 are received in the attachment recesses 20 and 22 of the first pressure nut component 12. The first pressure nut component 12 and the second pressure nut component 14 can be connected to one another via screws 34, which extend through the openings 32 and 40.

The pressure nut 10 can absorb high forces. The pressure nut only requires an internal thread on the first pressure nut component 12, due to which the manufacture of the pressure nut can be simplified and thus designed more cost-effectively. This is explained by the fact that coordination of the thread sections on the two pressure nut components is not necessary, as the second pressure nut component 14 is formed thread-free. The pressure nut 10 also permits the use of a wide range of materials for the manufacture of the pressure nut 10. The pressure nut 10 can be manufactured from extrudable or castable metals or plastics. Since the second pressure nut component 14 has no internal thread, the pressure nut 10 can also be manufactured from materials that can only be machined. Due to its structural design, pressure nut 10 or the first pressure nut component 12 can be pushed by the slot 16 onto a bushing, a cable or a tube. The pressure nut 10 can thereby be formed with a smaller outer diameter and thus be used in a more space-saving manner.

1. Pressure nut (10) for cable or tube connections, the pressure nut (10) comprising:
a first pressure nut component (12), which has a slot (16), and
a second pressure nut component (14), the second pressure nut component (14) being designed to close the slot (16) in the first pressure nut component (12),
the first pressure nut component (12) and the second pressure nut component (14) being connectable to one another.

2. Pressure nut (10) according to claim 1, the first pressure nut component (12) enclosing a larger angle than the second pressure nut component (14).

3. Pressure nut (10) according to claim 1, the second pressure nut component (14) being formed thread-free.

4. Pressure nut (10) according to claim 1, the first pressure nut component (12) and the second pressure nut component (14) having complementary attachment structures (20, 22, 30, 38), which serve to connect the first pressure nut component (12) and the second pressure nut component (14) to one another.

5. Pressure nut (10) according to claim 1, the first pressure nut component (12) having two end surfaces (50, 52), which define the slot between them.

6. Pressure nut (10) according to claim 5, the two end surfaces (50, 52) extending at least substantially parallel to one another.

7. Pressure nut (10) according to claim 1, the second pressure nut component (14) having a main body (54), which has two lateral surfaces (56, 58) extending at least substantially parallel to one another.

8. Pressure nut (10) according to claim 1, the pressure nut (10) having a through opening (38) with a section (12c, 14c) which acts as a clamping surface.

9. Assembly (BG) with at least one pressure nut (10) according to claim 1 and at least one bushing (78) connectable or connected to a cable (80).

10. Assembly (BG) according to claim 9, the assembly (BG) having at least one threaded sleeve (68).

11. Pressure nut (10) according to claim 2, the second pressure nut component (14) being formed thread-free.
